(19) United States
(12) Patent Application Publication
(10) Pub. No.: US 2020/0221548 A1
(43) Pub. Date: Jul. 9, 2020

(54) LIGHTING-BASED SENSING AND REPORTING

(71) Applicant: Cello Lighting, Inc., San Jose, CA (US)

(72) Inventor: Chenghung Pan, Palo Alto, CA (US)

(21) Appl. No.: 16/539,833

(22) Filed: Aug. 13, 2019

Related U.S. Application Data
(60) Provisional application No. 62/788,361, filed on Jan. 4, 2019.

(51) Int. Cl. H05B 33/08; H05B 37/02; F21V 23/04

(52) U.S. Cl. CPC H05B 33/0854; F21V 23/0471; H05B 37/0236; H05B 37/0263

(57) ABSTRACT

A light fixture includes a sensor such as an audio, temperature, or vibration sensor positioned to sense a possible emergency condition in an environment illuminated by a light source that receives electrical power through a power line from a remote power source. A controller in the light fixture receives a sensing result from the sensor and controls brightness from the light source so that the electrical power drawn through the power line varies in a manner that encodes the sensing result. A remote reporting unit connected to the power line can measure the power drawn, decode the sensing result, and report the sensing result through a network such as the Internet to a target such as an emergency response system.

### CROSS-REFERENCE TO RELATED APPLICATIONS

This patent document claims benefit of the earlier filing date of U.S. provisional Pat. App. No. 62/788,361, filed Jan. 4, 2019, which is hereby incorporated by reference in its entirety.

### BACKGROUND

Outdoor light fixtures may act as platforms for sensors particularly because the sensors can receive power through the outdoor light fixtures. However, while an outdoor light fixture normally requires and has a power supply that is an available resource for sensors, outdoor light fixtures generally do not require or have network connections. This lack of a network connection can make transmission or reporting of sensing results difficult. Two solutions are commonly used to transmit sensing results through a network such as the Internet. A wireless solution provides network connections through wireless devices, such as Wi-Fi, ZigBee, 4G, or 5G devices. A wired solution uses copper wires or optical fibers to carry data. The wireless solution may be impractical or too expensive for outdoor lighting systems particularly if the distance between an outdoor light fixture and an Internet router is too great, and the wired solution may be too costly or impractical if new data lines need to be run or extended to outdoor light fixtures.

### SUMMARY

In accordance with an aspect of the invention, a lighting-based sensing system uses power lines to transmit sensor results. A system may particularly include a sensing unit and a reporting unit, which are connected through a power line. The sensing unit may be mounted on or may be part of a light fixture and may include, for example, one or more sensors and a light-level controller to control a brightness level of the light fixture. The light-level controller may change or set the brightness level in a manner that depends on a sensor result from the sensor, so that the power that the light fixture consumes may represent or encode the sensor result and/or an identity or location of the light fixture. The reporting unit may include an electrical meter connected to measure the current or power that the light fixture consumes and may further include a processor configured to convert the electrical measurements into received data, which may be transmitted to a target through a network connection.

In one implementation, a light fixture encodes the sensing results from a sensor as a pattern or sequence of brightness or illumination power levels to create a pattern of power use variation. A remote electrical meter can measure the pattern of power use from a long distance and the measured result from the electrical meter can be decoded to determine the sensor result, which in turn may be transmitted through a conventional network to a target recipient.

### BRIEF DESCRIPTION OF THE DRAWINGS

FIG. 1 is a block diagram of a lighting and sensing system including one or more light fixtures capable of transmitting sensor results through parallel power lines.

FIG. 2 is a block diagram of a lighting and sensing system including one or more light fixtures capable of transmitting sensor results through a shared power line.

FIG. 3 is a block diagram of one implementation of a lighting system with audio sensing that may be used for gunshot detection and reporting.

FIG. 4 is a block diagram of one implementation of lighting system with motion sensing that may detect, count, or otherwise quantify and report motion in an illuminated area.

FIG. 5 is a block diagram of one implementation of a lighting system with temperature, smoke, or other fire sensing that may be used for fire detection and reporting.

FIG. 6 is a block diagram of a specific implementation of a lighting system with seismic sensing that may be used for earthquake detection and reporting.

FIG. 7 is a block diagram of one implementation of lighting system with chemical or pollution sensing that may detect and report contamination in an illuminated area.

The drawings illustrate examples for the purpose of explanation and are not of the invention itself. Use of the same reference symbols in different figures indicates similar or identical items.

### DETAILED DESCRIPTION

Lighting systems, which may include one or more outdoor light fixture such as streetlights, can include sensors and provide data transmission via power lines by varying brightness or other power use of the light fixtures to encode data such as sensor results. The sensors may, for example, sense emergency conditions or indicators such as loud noises indicating gunshots, smoke or high temperatures indicating a fire, vibrations indicating earthquakes or explosions, or the amount or presence of chemicals or pollution in areas illuminated by the light fixtures. Alternatively, the sensors may monitor movement, traffic, or other non-emergency activity in illuminated areas. A remote reporting unit may monitor the power use of the one or more light fixtures, decode data encoded in power use by the light fixtures, and report the decoded data through a network such as the Internet to an appropriate target, e.g., to an emergency response system.

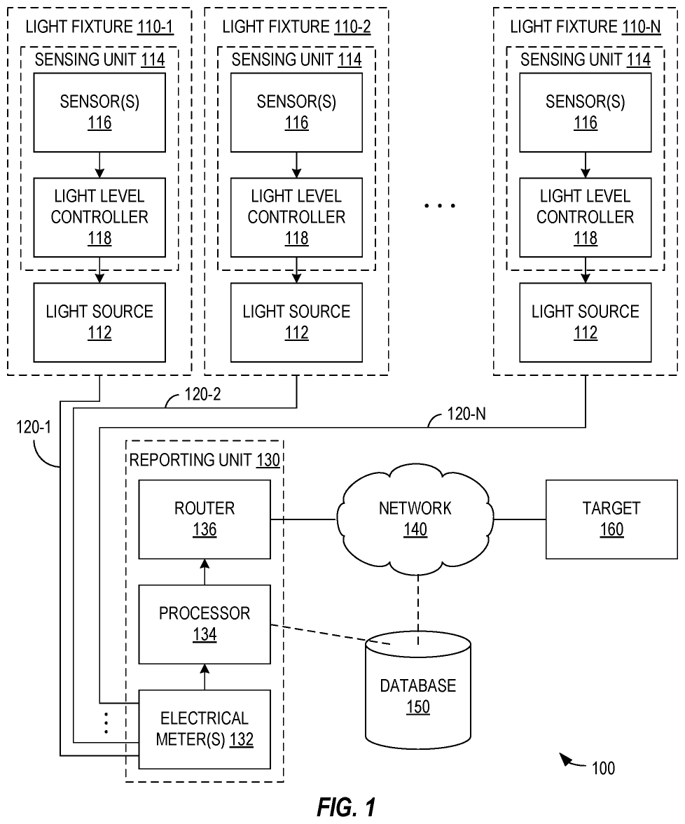

FIG. 1 shows one implementation of a lighting-based sensing and reporting system 100 that uses one or more light fixtures 110-1 to 110-N, generically referred to herein as light fixtures 110, that receive power and transmit data through parallel power lines 120-1 to 120-N, generically referred to herein as power lines 120. Each light fixture 110 may be an outdoor light such as a streetlight, and each light fixture 110 has a unique geographical location, e.g., light fixtures 110-1 to 100-N may be located at intervals along a street or distributed over an area such as a parking lot, a park, or any area where lighting may be desired. For lighting, each light fixture 110 includes a light source 112, which may be relatively high luminosity light source such as a sodium vapor lamp, a mercury vapor lamp, or a high luminosity LED area light. Light source 112 in general is dimmable, meaning illumination from light source 112 may be changed by changing the electrical power driving or consumed in light fixture 110.

For sensing, each light fixture 110 further includes a sensing unit 114, and each sensing unit 114 includes one or more sensors 116 and a light-level or dimming controller 118. Each sensor 116, in general, may include one or more sensing system of any types that are capable of detecting conditions or measuring characteristics of light fixture 110 or of an environment surrounding light fixture 110. For example, sensor 116 may be a motion sensor, an audio sensor, a light sensor, a temperature sensor, a fire flame sensor, a smoke detector, a sensor of a concentration or presence of a specific chemical or a specific class of chemicals, or a vibration sensor or other seismic sensor. Sensor 116 is further adapted to provide sensor results, e.g., a digital or analog signal indicating a detected condition or a measured value, to controller 118. In accordance with an implementation disclosed herein, controller 118, which may be a microprocessor or microcontroller with associated memory and interface circuitry, includes circuitry to control the brightness or illumination level of light source 112, and controller 118 is configured or programmed to alter the brightness level of light source 112 based on sensor results from sensor 116. For example, light level controller 118 may determine an encoding of sensor data as variations in light level and provide a digital or analog control signal to light source 112 via a standard light level control protocol, such as a 0-10 v dimming interface, 1-10 v dimming interface, pulse width modulation (PWM) dimming interface, or any existing light level dimming interface to cause light source 112 to vary emitted illumination in accordance with the determined encoding.

System 100 further includes a reporting unit 130 that is coupled to power lines 120 at a location that may be remote from one or more of light fixtures 110. Reporting unit 130 may, for example, be at a nearby electrical control cabinet with electrical breakers for the one or more circuits connected to light fixtures 110. Reporting unit 130 includes one or more electrical meters 132, a processor 134, and a router 136. In the implementation of FIG. 1, each of the light fixtures 110-1 to 110-N is exclusively associated with a corresponding one of power lines 120-1 to 120-N, which provides power to the light fixture, and electrical meters 132 connect to power lines 120-1 to 120-N. Electrical meters 132 may, for example, include N amp meters that measure the respective currents supplied on power lines 120-1 to 120-N, N voltage meters that measure respective voltage drops on power lines 120-1 to 120-N, or any other meter capable of providing measurements indicating the power consumption through each power line 120. Electrical meters 132 are further adapted or configured to provide to processor 134 electrical measurements, e.g., digital or analog signals indicating measured currents, voltage drops, or power consumptions on respective power lines 120.

In order for a specific light fixture 110 to transmit a sensor result to reporting unit 130, controller 118 in that fixture 110 may encode information or data such as the sensing result from sensor 116 into a pattern or sequence of dimming (or brightening) of the associated light source 112. Controller 118 then operates light source 112 at a series of power levels according to the determined pattern to create a pattern of power use variation of the light fixture 110. In general, the operation of light source 112 may occur while light source 112 is being used to illuminate a surrounding environment. In some cases, the variations may be sufficiently rapid to avoid flickering that the average person is able to sense. Alternatively, the variations in light level may be noticeable and provide a visible signal or local alarm indicating a sensed result at the location of the light fixture 110. In reporting unit 130, electrical meters 132 can measure the power use on each line 120, processor 134 may process measurements from electrical meters 132 to detect patterns in the power use and may decode the power use patterns to extract transmitted information. The transmitted information may indicate the sensor result or data from the light fixture 110 and may further indicate a light fixture ID that distinguishes the transmitting light fixture 110 from other light fixtures 110. Alternatively, with only one light fixture 110-1 to 110-N on each of power lines 120-1 to 120-N, the identity of the transmitting light fixture 110 is known from power line 120 on which the encoded transmission was received and the transmitted information does not need to identify the transmitting light fixture 110. Physical location information (such as a Google Map hyperlink) for light fixtures 110 (and specifically for the transmitting light fixture) may be stored in advance in a database 150. Database 150 may be at the same location as reporting unit 130 and directly accessible by processor 134 or router 136, or alternatively database 150 may be elsewhere and connected to a network 140, which is accessible through router 136. Processor 134 may be configured, e.g., may execute specific software or firmware, to transmit through the router 136 and network 140 to one or more target recipients 160, one or more messages based on the decoded sensor result and the corresponding location information of the sensing unit 114. In general, network 140 may be a private network or a public such as the Internet, and an address for each target 160 may be stored in database 150, which available to processor 134 or router 136.

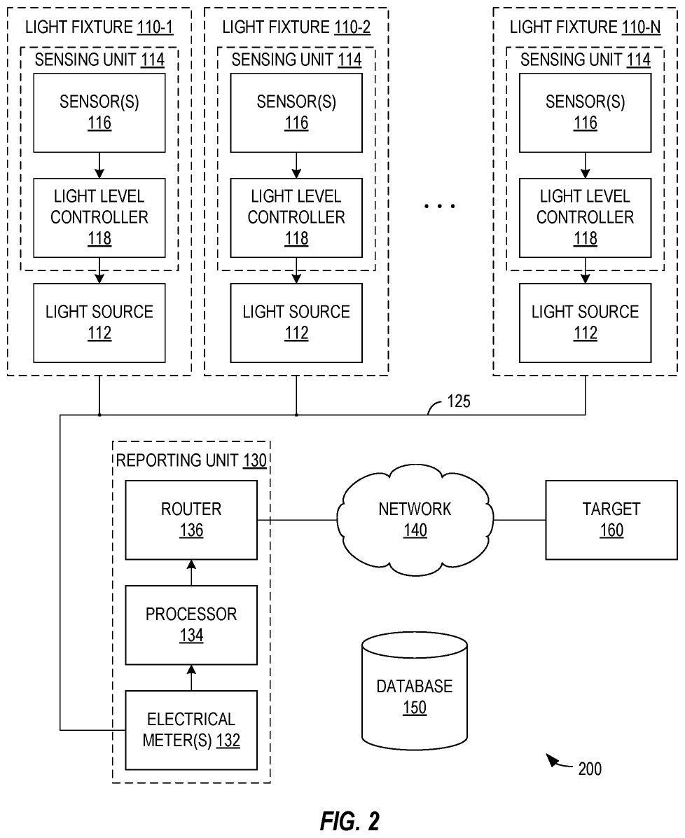

FIG. 2 is a block diagram of a lighting-based sensing and reporting system 200 that includes many of the same elements as system 100 of FIG. 1. System 200 differs from system 100 in that multiple light fixtures 110-1 to 110-N share a power line 125 that is connected to electrical meter(s) 132 in reporting unit 130. Each light fixture 110 may operate in system 200 in substantially the same manner as in system 100. In particular, when a sensor 116 in a sensing unit 114 has a sensing result to be reported, light-level controller 118 in that sensing 114 operates light source 112 with a pattern of illumination levels that encodes information reflecting the sensing result. The pattern or the encoded data may also identify which light fixture 110 is transmitting. Electrical meters 132 measure power line 125, e.g., measure the total current drawn, the total power used, or the total voltage drop on shared power line 125. Processor 134 in reporting unit 130 may be configured to analyze the measurements from electrical meters 132 to identify patterns corresponding to encoded data. In system 200, transmissions from two or more light fixtures 110 may overlap, but light fixtures may 110 be configured to use different encoding techniques that enable processor 134 to separate transmissions. For example, each light fixture may use a different frequency of light level variation so that processor 134 can distinguish different transmissions from differences in frequency. When processor 134 in system 200 decodes one or more transmission from light fixtures 110, processor 134 may transmit one or more messages to one or more targets 160 through router 136 and network 140.

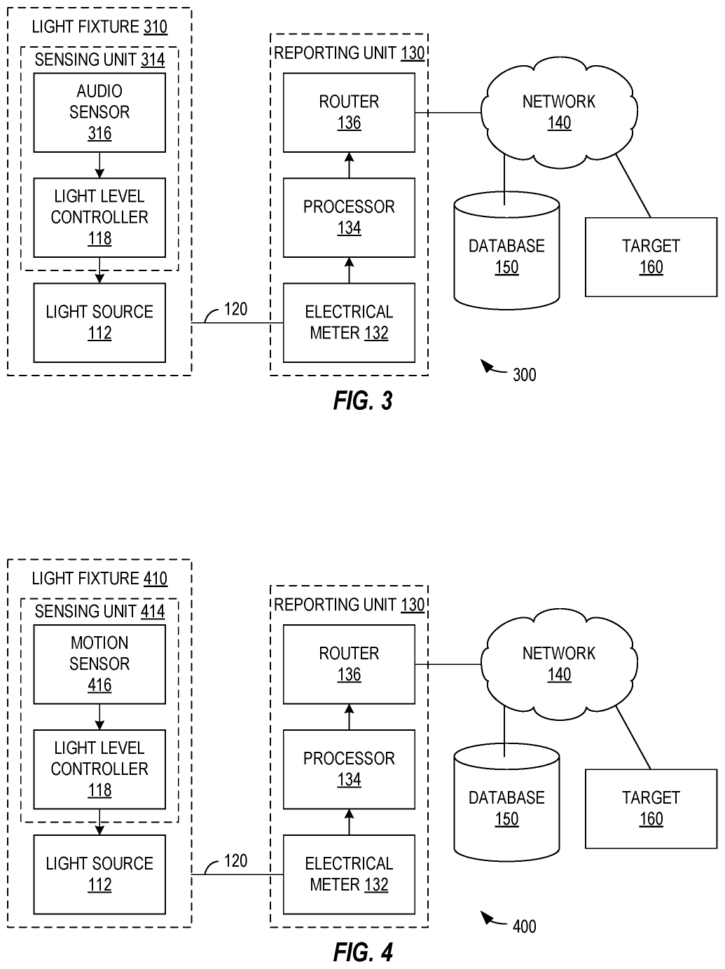

FIG. 3 is a block diagram of a specific implementation of a lighting-based sensing and reporting system 300 using a light fixture 310 that receives power through a power line 120. Light fixture 310 includes a light source 112 to illuminate an environment, e.g., an outdoor area, and a sensing unit 314 to sense sound indicating gunshots in or near the illuminated environment. For this purpose, sensing unit 314 includes an audio sensor 316 such as a microphone. Sensing unit further includes a light-level controller 118 to control the brightness level of light source 112 based on sensing results from audio sensor 316. System 300 further includes a reporting unit 130 connected to light fixture 310 through power line 120, and reporting unit 130 includes an electrical meter 132, a processor 134, and an router 136 such as described above. In one example implementation, light-level controller 118 in light fixture 310 may be configured to only transmit sensing results from audio sensor 316 when the sensing results suggest or indicate a gunshot, e.g., when sensing results from audio sensor 316 have a high volume or a variation over time that suggests or indicates a possible gunshot. Controller 118 may be configured to analyze measurements from audio sensor 316 and may transmit an alarm signal or other sensing result or data only when the analysis indicates a possible gunshot. In an alternative implementation, controller 118 may encode sensing results for analysis in reporting unit 130. In order to transmit a sensing result from sensor 316 in sensing unit 314 to router 136 in reporting unit 130, controller 118 may encode the sensing result into a pattern of dimming or illumination levels of light source 112 to create a pattern of power use variation of light fixture 310. In one implementation, if the sensing result of the audio sensor 116 is higher than the pre-defined threshold, light-level controller 118 operates light source 112 according to a predetermined gunshot-warning pattern of light output, for example, with the brightness level of light source 112 going to 70% then 30% then 70% then 30% of full brightness level at a frequency of about 1 Hertz or more. The pattern of light output corresponds to a power use pattern provided through power line 120. Electrical meter 132 measures the power used through power line 120, and processor 134 process the measured power use to detect the predetermined gunshot-warning pattern. The physical location information of light fixture 310 and a network address of target recipient of gunshot alarms may have been stored in advance in database 150, which is accessible through router 136. Processor 134, upon identifying the gunshot-warning pattern, may transmit an alarm message including the location information of sensing unit 316 through the router 136 to one or more target 160, which may be a targeted law enforcement agency or emergency response system.

FIG. 4 shows another specific implementation of a lighting-based sensing reporting system 400 using a light fixture 410 that receives power through a power line 120. System 400 may be used to provide illumination in an environment surrounding light fixture 410 and may be used to report or monitor movement in or around the illuminated environment. System 400 includes a sensing unit 414 in or mounted on light fixture 410 and a reporting unit 130 that may be remote from light fixture 410 and connected to light fixture 410 through power line 120. Sensing unit 414 including a motion sensor 416, a light source 112, and a light-level controller 118 to control the brightness level of light source 112. Motion sensor 414 may be use to detect motion in an area around light fixture 410 or count moving objects such as vehicles. Reporting unit 130 includes an electrical meter 132, a processor 134, and an router 136 such as described above. In order to transmit movement data based on sensing results from sensor 416, processor 118 may encode the sensing result from sensor 416 into a pattern of dimming the light level of light source 112 to create a pattern of power use variation of light fixture 110. In this implementation, if the sensing result from sensor 416 is detected motion during a given time interval, controller 118 may operate light source 112 according to a predetermined pattern of light output, for example, with the bright-level of the light fixture 120 going to 75% then 25% then 75% then 25% then 75% of full brightness level at a predetermined frequency for the changes. The pattern of light output corresponds to a similar power use pattern of 50% to 10% to 50% to 10% to 50% of the full power level of light fixture. In reporting unit 130, electrical meter 132 measures the power use on power line 120, and processor 134 analyzes the power-use measurements from electrical meters 132 to detect the predetermined pattern indicating. Processor 134 may obtain physical location information of light fixture 410 from database 150, which may accessible from database 150 through router 136, and may generate a report or message based on the sensing location. The report may be transmitted to targets 160, which processor 134 may also select based on type of motion detected.

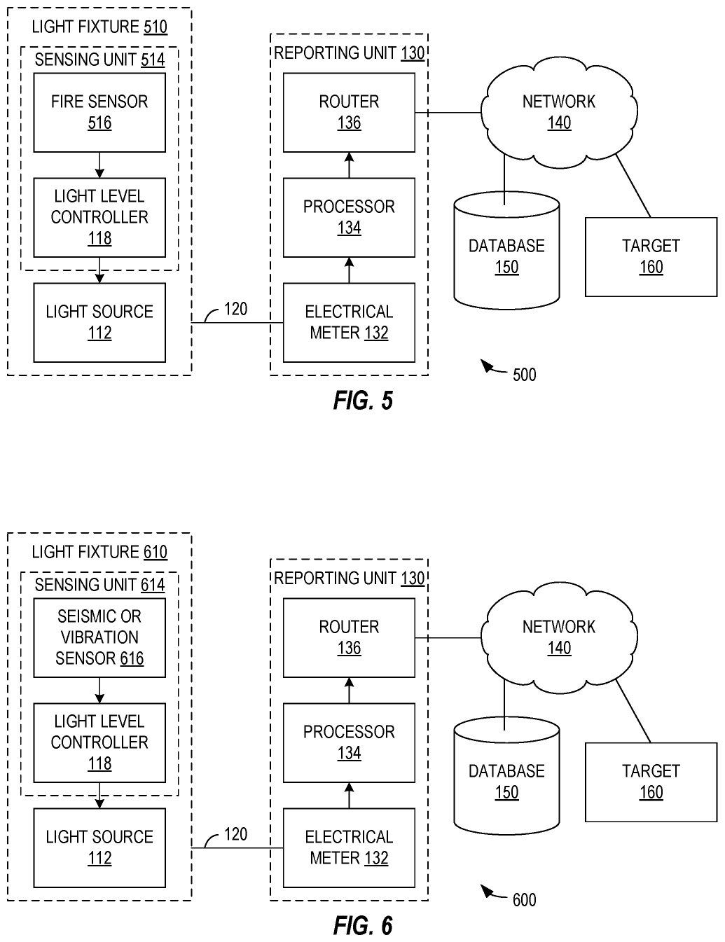

FIG. 5 shows a block diagram of yet another implementation of a lighting-based sensing reporting system 500 using a light fixture 510 that receives electrical power through a power line 120. System 500 includes a sensing unit 514 in or mounted on light fixture 510 and a reporting unit 130 that connects to light fixture 510 through power line 120. Sensing unit 514 includes a fire sensor 516, e.g., a temperature sensor or a smoke detector, and a light-level controller 118 for a light source 112. As disclosed above, light-level controller 118 may be configured to control a brightness level of light source 112 based on sensing results from fire sensor 516. Reporting unit 130 includes an electrical meter 132, a processor 134, and an router 136 such as described above. In order to transmit a sensing result from sensor 516 in sensing unit 514 to router 136 in reporting unit 130, processor 118 may operate light source 112 according to a pattern or sequence of light levels that creates a specific pattern of power use variation of light fixture 110. In this implementation, if the sensing results from sensor 516 indicate or suggest a fire near light fixture 510, e.g., sensor 516 measures a temperature or smoke concentration higher than a pre-defined threshold, controller 118 operates light fixture 510 according to a special fire-alarm pattern of light output, e.g., with the bright-level of light source stepping to 10% then 90% then 50% then 90% then 10% of full brightness level with a specific frequency for brightness level changes. The pattern of light output corresponds to a similar power use pattern, e.g., 10% then 90% then 50% then 90% then 10% of the full power level, and electrical meter 132 can measure the power drawn on line 120. Processor 134 analyzes power measurements from electrical meter 132 to detect patterns, and processor 134 may perform a fire alarm procedure if the fire-alarm pattern is detected. In particular, processor 134 can access database 150 to retrieve physical location information (such as the Google Map hyperlink) for light fixture 510 and to retrieve one or more target addresses for fire alarms associated with the location of light fixture 510. Processor 134 can then compose and transmit a fire alarm message to the appropriate target(s) 160, for example to report to the targeted fire fighter agencies, through the router 136 and network 140.

FIG. 6 shows another implementation of a lighting-based sensing reporting system 600 using a light fixture 610 that receives power through a power line 120. System 600 may be used to provide illumination in an environment surrounding light fixture 610 and may be used to report a possible earthquakes or explosions. System 600 includes a sensing unit 614 in or mounted on light fixture 610 and a reporting unit 130 that may be remote from light fixture 610 and is connected to light fixture 610 through power line 120. Sensing unit 614 including an seismic or vibration sensor 616, a light source 112, and a light-level controller 118 to control the brightness level of light source 112. Reporting unit 130 includes an electrical meter 132, a processor 134, and an router 136 such as described above. In order to transmit an alarm or warning signal based on sensing results from sensor 616, processor 118 may generate an alarm signal or encode the sensing result from sensor 616 into a pattern of dimming the light level of light source 112 to create a pattern of power use variation of light fixture 110. In this implementation, if the sensing result from sensor 616 is a measurement of vibrations higher than the pre-defined threshold, controller 118 operates light source 112 according to a special seismic-warning pattern of light output, for example, with the bright-level of the light fixture 120 going to 50% then 10% then 50% then 10% then 50% of full brightness level at a predetermined frequency for the changes. The pattern of light output corresponds to a similar power use pattern of 50% to 10% to 50% to 10% to 50% of the full power level of light fixture. In reporting unit 130, electrical meter 132 measures the power use on power line 120, and processor 134 analyzes the power-use measurements from electrical meter 132 to detect the characteristic pattern indicating earthquake or explosion detection. Processor 134 may obtain physical location information of light fixture 610 from database 150, which may accessible from database 150 through router 136, and may generate an earthquake alarm message based on the sensing location. The alarm message may be transmitted to targets 160, which processor 134 may also select based on type of alarm and the sensing location. In particular, an earthquake alarm may be automatically reported to target residents or agencies, through the router 136 and network 140, e.g., through the Internet.

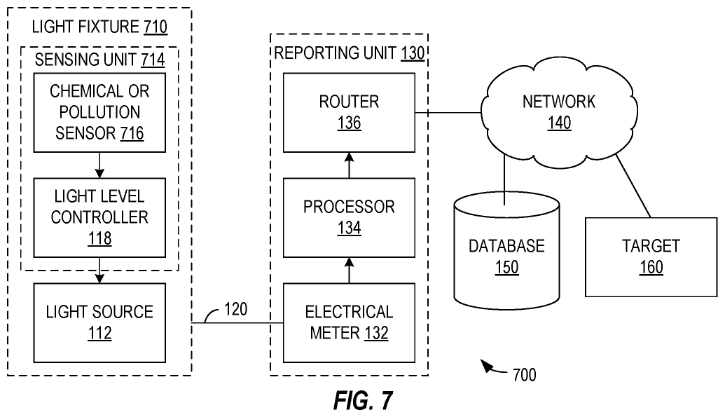

FIG. 7 shows a block diagram of yet another implementation of a lighting-based sensing reporting system 700 using a light fixture 710 that receives electrical power through a power line 120. System 700 includes a sensing unit 714 in or mounted on light fixture 710 and a reporting unit 130 that connects to light fixture 710 through power line 120. Sensing unit 714 includes a chemical or pollution sensor 716. Sensor 716 may particularly be able to detect the presence or measure the concentration of one or more specific chemicals in the atmosphere around light fixture 710, detect specific radiation, or measure a radiation level around light fixture 710. The detected chemicals, radiation, pollution, or other harmful condition may be chosen according to the location of light fixture 710. For example, sensor 716 may be adapted to detect specific chemicals or pollution that may be produced by local activities such as nearby manufacturing. Light-level controller 118 may be configured to control a brightness level of light source 112 based on sensing results from sensor 716. Reporting unit 130 includes an electrical meter 132, a processor 134, and an router 136 such as described above. In order to transmit a sensing result from sensor 716 in sensing unit 714 to router 136 in reporting unit 130, processor 118 may operate light source 112 according to a pattern or sequence of light levels that creates a specific pattern of power use variation of light fixture 110 that corresponds to the sensing result. In this implementation, if the sensing results from sensor 716 indicate or suggest unsafe or undesirable levels of pollution near light fixture 710, controller 118 operates light fixture 710 according to a special warning or alarm pattern of light output, e.g., with the bright-level of light source stepping to 20% then 80% then 20% then 80% then 20% of full brightness level with a specific frequency for brightness level changes. It may be desired that the specific lighting pattern, e.g., the frequency and amplitude of changing light levels, be obvious to or easily observed by people, so that light fixture 710 signals the presence of a chemical or other harmful condition that people might not otherwise be able to sense. Processor 134 analyzes power measurements from electrical meter 132 to detect patterns, and processor 134 may perform a pollution alarm procedure if the pollution alarm pattern is detected. In particular, processor 134 can access database 150 to retrieve physical location information (such as the Google Map hyperlink) for light fixture 710 and to retrieve one or more target addresses for fire alarms associated with the location of light fixture 710. Processor 134 can then compose and transmit message(s) to the appropriate target(s) 160.

Yet another implementation of a lighting-based sensing reporting system may employ sensing units with multiple types of sensors in one or more light fixtures, and the sensing unit of a light fixture may transmit different sensing results using different power use sequences or patterns. For example, a sensing unit associated with a light fixture may use a gunshot-warning pattern, e.g., 70% then 30% then 70% then 30% of full power, a seismic-warning pattern, e.g., 50% then 10% then 50% then 10% then 50% of full power, or a fire-alarm pattern, e.g., 10% then 90% then 50% then 90% then 10% of full power, to transmit a sensing result through a power line to the reporting unit. The reporting unit can then analyze electrical measurements of the interconnecting power line to detect any of the predetermined patterns, and when a known pattern is detected, send messages or reports based on the detected pattern to targets appropriate to the messages.

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A system comprising a light fixture including:
a sensor positioned to sense a condition in an environment;
a light source configured to illuminate the environment, the light source receiving electrical power through a power line from a remote power source; and
a controller connected to receive a sensing result from the sensor and to control a brightness of illumination from the light source, the controller being configured to vary the brightness of the illumination from the light source so that the electrical power drawn through the power line varies in a manner that represents the sensing result.

2. The system of claim 1, wherein
the sensor comprises an audio sensor, and wherein
in response to the sensor result indicating a sound associated with a gunshot, the controller is configured to vary the brightness of the illumination from the light source so that the electrical power drawn through the power line varies in a manner that represents a gunshot alarm.

3. The system of claim 1, wherein
the sensor comprises a fire sensor, and wherein
in response to the sensor result indicating a fire, the controller is configured to vary the brightness of the illumination from the light source so that the electrical power drawn through the power line varies in a manner that represents a fire alarm.

4. The system of claim 3, wherein the fire sensor comprises one of a smoke sensor and a temperature sensor.

5. The system of claim 1, wherein
the sensor comprises a motion sensor, and wherein
in response to the sensor result indicating a motion, the controller is configured to vary the brightness of the illumination from the light source so that the electrical power drawn through the power line varies in a manner that represents motion data.

6. The system of claim 1, wherein
the sensor comprises a vibration sensor, and wherein
in response to the sensor result indicating an emergency condition, the controller is configured to vary the brightness of the illumination from the light source so that the electrical power drawn through the power line varies in a manner that represents an alarm.

7. The system of claim 1, wherein the emergency condition is one of an earthquake and an explosion.

8. The system of claim 1, wherein the light fixture is an outdoor light.

9. The system of claim 8, wherein the light fixture is a streetlight.

10. The system of claim 1, further comprising a reporting unit that is coupled to the power line and is remote from the light fixture, wherein the reporting unit comprises:
an electrical meter coupled to the power line; and
a second controller coupled to receive measurements from the meter, the controller being configured to process the measurements to detect a predetermined pattern of variations in the electrical power drawn through the power.

11. The system of claim 10, where in the second controller is further configured to identify a location of the light fixture.

12. The system of claim 11, wherein the reporting unit further comprises a network connection, and wherein the second controller is further configured to send a message based on the predetermined pattern detected through the network connection to a target, the message indicating the location of the light fixture.

13. The system of claim 10, wherein the reporting unit further comprises a network connection, and wherein the second controller is further configured to send a message based on the predetermined pattern detected through the network connection to a target.

14. The system of claim 13, wherein the second controller is further configured to select the target based on the predetermined pattern detected.

15. The system of claim 13, wherein the target corresponds to an emergency response system.
